(19) United States
(12) Patent Application Publication
(10) Pub. No.: US 2026/0339720 A1
(43) Pub. Date: Oct. 29, 2026

(54) ON-DEMAND GENERATION OF VIRTUAL ACCELERATORS

(71) Applicant: INTERNATIONAL BUSINESS MACHINES CORPORATION, Armonk, NY (US)

(72) Inventors: Deanna Postles Dunn Berger, Hyde Park, NY (US); Ekaterina M. Ambroladze, Ridgefield, CT (US); Tabari Alexander, Hyde Park, NY (US); Qiqing Christine Ouyang, Yorktown Heights, NY (US); Elpida Tzortzatos, Lagrangeville, NY (US); Alper Buyuktosunoglu, White Plains, NY (US); Bulent Abali, Tenafly, NJ (US); Cedric Lichtenau, Stuttgart (DE)

(21) Appl. No.: 19/189,512

(22) Filed: Apr. 25, 2025

(51) Int. Cl. G06F 9/50

(52) U.S. Cl. CPC G06F 9/5027

(57) ABSTRACT

A virtual accelerator is dynamically constructed on-demand to be used to execute one or more artificial intelligence tasks. The dynamically constructing the virtual accelerator on-demand includes determining, based on the one or more artificial intelligence tasks to be executed, computing resources to be allocated to the virtual accelerator on-demand. The computing resources are allocated to the virtual accelerator on-demand. The allocating of the computing resources includes assigning at least a portion of the computing resources to the virtual accelerator on-demand from standby computing resources. The virtual accelerator is to execute the one or more artificial intelligence tasks based on being allocated the computing resources.

### BACKGROUND

One or more aspects relate, in general, to facilitating processing within computing environments, and in particular, to improving processing within computing environments that execute different types of workloads and/or tasks.

The demand for computing resources continues to increase. For instance, customers of enterprise computing systems (e.g., mainframe computing systems) demand large-capacity, reliable and low-latency memory subsystems. Further, there is an increasing demand on such systems for accelerator processing (e.g., hardware accelerated compute resources or artificial intelligence compute resources). The demand for hardware accelerated compute resources on enterprise computing systems is on the rise due to expanding use cases for, e.g., real-time inference acceleration, generative artificial intelligence, fine-tuning, security, encryption, etc.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one computing device to perform computer operations. The computer operations include dynamically constructing a virtual accelerator on-demand to be used to execute one or more artificial intelligence tasks. The dynamically constructing the virtual accelerator on-demand includes determining computing resources to be allocated to the virtual accelerator on-demand. The determining is based on the one or more artificial intelligence tasks to be executed. The computing resources are allocated to the virtual accelerator on-demand based on the computing resources determined to be allocated. The allocating the computing resources includes assigning at least a portion of the computing resources to the virtual accelerator on-demand from standby computing resources. The computing resources allocated to the virtual accelerator are to be used by the virtual accelerator to execute the one or more artificial intelligence tasks.

In one or more aspects, a computer program product is provided. The computer program product includes a set of one or more computer-readable storage media and program instructions, collectively stored in the set of one or more computer-readable storage media, for causing at least one computing device to perform computer operations. The computer operations include receiving by a virtual accelerator an indication of an artificial intelligence task to be executed by the virtual accelerator. The virtual accelerator is dynamically constructed on-demand, in which the virtual accelerator is dynamically allocated computing resources on-demand based on the artificial intelligence task to be executed. At least a portion of the computing resources allocated on-demand are from standby computing resources. The artificial intelligence task is executed by the virtual accelerator. A result of the executing the artificial intelligence task is output from the virtual accelerator. The result is provided to an operating system requesting that the artificial intelligence task be executed.

Computer-implemented methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate, perform and/or use one or more aspects of the present disclosure;

FIG. 2 depicts one example of the on-demand virtual accelerator construction code of FIG. 1, in accordance with one or more aspects of the present disclosure;

FIG. 3A depicts one example of an on-demand virtual accelerator construction and use process, in accordance with one or more aspects of the present disclosure;

FIG. 3B depicts one example of hardware capacity categorization, in accordance with one or more aspects of the present disclosure;

FIG. 4 depicts one example of a communications process between various entities to construct a virtual accelerator on-demand, in accordance with one or more aspects of the present disclosure;

FIG. 5 depicts one example of a computing resources determination/selection process to provide computing resources to construct a virtual accelerator on-demand, in accordance with one or more aspects of the present disclosure;

FIG. 6 depicts one example of system hardware that includes an enabled system configuration and on-demand memory/compute resources, in accordance with one or more aspects of the present disclosure; and

FIG. 7 depicts one example of a machine learning training system used in accordance with one or more aspects of the present disclosure.

### DETAILED DESCRIPTION

In accordance with one or more aspects of the present disclosure, a capability is provided to facilitate processing within a computing environment. In one or more aspects, the capability includes improving performance, including processing speed, in those computing environments that support different types of workloads and/or tasks, such as enterprise workloads (e.g., mainframe workloads) and artificial intelligence processing or tasks.

The demand for computing resources continues to increase. For instance, customers of enterprise computing systems (e.g., mainframe computing systems) demand large-capacity, reliable and low-latency memory subsystems. Further, there is an increasing demand on such systems for accelerator processing (e.g., hardware accelerated compute resources or artificial intelligence compute resources). The demand for hardware accelerated compute resources on enterprise computing systems (e.g., artificial intelligence compute resources on mainframe computing systems) is on the rise due to expanding use cases for, e.g., real-time inference acceleration (machine learning process in which models generate predictions or provide output as new input data is received), generative artificial intelligence, fine-tuning, security, encryption, etc.

Existing solutions include adding hardware accelerators, such as artificial intelligence unit engines, in the on-chip silicon and attaching them directly to a level of a shared hierarchical cache (e.g., L3/vL3 (level 3/virtual level 3 shared cache)) or attaching them to a virtual L4 (level 4) cache via an on-drawer connect and then having the processor core instance that is running selected code (e.g., Neural Network Processing Assist code offered by International Business Machines Corporation, Armonk, N.Y. and/or other code offered by International Business Machines Corporation and/or other entities) prefetch the data to be inferenced into the L2 (level 2) cache of the processor core running the code (where the hardware acceleration engine is on-chip) or the vL3 cache of the chip containing the hardware acceleration engine. These solutions rely on memory sticking patterns and prefetching into the shared system caches.

Accelerated compute resources (e.g., artificial intelligence hardware) located at or near processors can degrade traditional enterprise workload performance. It can strain other system workload performance without careful management of the shared system caches. However, not all artificial intelligence tasks are the same. Some near processor artificial intelligence compute is beneficial for some use cases (e.g., workloads, tasks, etc.), while some memory intensive artificial intelligence workloads and/or tasks benefit from being physically located much closer (on chip/drawer) to large blocks (e.g., 10-100 terabytes) of memory. Different artificial intelligence tasks use different memory/compute (e.g., processor) capacity sizes and ratios. Some artificial intelligence tasks are latency sensitive using real-time inference, while others may use more bandwidth but can run in the background underneath/in parallel with non-artificial intelligence or real-time artificial intelligence workloads.

Compute (e.g., processor) capacity that is attached via an interconnect (e.g., peripheral component interconnect express (PCIe) and/or other interconnects) helps distribute the artificial intelligence compute, but shared memory hierarchy performance may still be impacted if an artificial intelligence unit working set is larger than, e.g., the PCIe-attached accelerator caches. Thus, in one example, non-performance critical artificial intelligence compute and its memory space are to be isolated from performance critical workloads, while supplying the acceleration job with the resources and high memory bandwidth it is to use.

While near-processor compute usage is optimal for some use cases (e.g., real-time artificial intelligence inference), it is not necessary for all use cases. Some use cases, such as training and/or fine-tuning artificial intelligence compute, may be performed in or near memory with little to no negative performance impact on other system workloads that leverage the system caches.

Existing operating system dispatch decision making algorithms have limited visibility and ability to control the cache and memory utilization and access behaviors, leading to unintended performance implications on unrelated workloads sharing the system’s cache, or even on the calling workload itself.

Attachment of hardware accelerators into enterprise systems drives more heterogeneous and non-traditional memory access patterns. Memory sticking mitigates this somewhat but uses detailed knowledge of the behavior patterns of different acceleration algorithms. Recent market trends indicate storage as a service is taking over traditional enterprise storage solutions, highlighting the fact that more robust, generic and scalable access to memory, including large inference data sets, are to be utilized.

In one or more aspects, a hardware/software integrated intelligent memory compute acceleration subsystem is provided that identifies that virtual acceleration is to be used, constructs (e.g., generates, creates, builds, etc.) and assigns virtual accelerators (may also be referred to as virtual acceleration engines, virtual adapters, virtual machines) out of, e.g., unused memory and compute capacity, dispatches work to the virtual accelerators, deconstructs (e.g., takes down, removes, deallocates, unassigns computing resources, etc.) the virtual accelerators after completion of the task and enables reuse for the next task.

In one or more aspects, the virtual accelerators are constructed on-demand and are used as specialized accelerators of selected tasks, such as artificial intelligence tasks (e.g., inferencing, generative artificial intelligence, training, fine-tuning, security, encryption, etc.). The virtual accelerators are configured to accelerate artificial intelligence, including machine learning, tasks (e.g., workloads, applications, programs, etc.).

In one or more aspects, a hardware configuration (e.g., an abstracted hardware host configuration) is created that is variably customized to a current task (e.g., an artificial intelligence task). In one or more aspects, a variable pool of hardware compute silicon is constructed on-demand and abstracted for software as a virtual accelerator. The software, including, but not limited to the operating system, is able to leverage the virtual accelerator based on need, and then, deconstruct the virtual accelerator based on no longer being needed.

In one or more aspects, based on an artificial intelligence task (e.g., inference, generative artificial intelligence, training, fine-tuning, security, encryption, etc.) request, software (e.g., the operating system) determines the type and/or amount of computing resources (e.g., compute (e.g., processor)/memory capacity) to be used to accomplish the task according to, e.g., a governing service level objective. An indication of the identified computing resources (e.g., parameters) is then passed by, e.g., the operating system to, e.g., the system firmware. Firmware includes, e.g., the microcode or millicode of a processor. It includes, for instance, the hardware-level instructions and/or data structures used in implementation of higher-level machine code. In one embodiment, it includes, for instance, proprietary code that is typically delivered as microcode or millicode that includes trusted software, microcode or millicode specific to the underlying hardware and controls operating system access to the system hardware.

The firmware, as an example, performs on-demand construction of a virtual accelerator that includes the indicated computing resources capabilities. This virtual accelerator is configured with the requested computing resources and, in one or more embodiments, a minimal runtime environment to execute one or more artificial intelligence tasks (e.g., process inference programs designed to utilize the computing resources). As an example, the minimal runtime environment includes a streamlined set of existing firmware and software constructs utilized to interact with the computing resources to enable the communication used to pass details and/or parameters of the task to and from the computing resources. To configure the virtual accelerator with the minimal runtime environment, the firmware provides (e.g., uploads, installs, enables, assigns, etc.) the firmware and software constructs to the virtual accelerator. Other examples are possible.

In one example, the originating task (e.g., the operating system) compiles an artificial intelligence model (a program trained on selected data) into a compiled program, and uses shared memory segments to pass the compiled program and inputs to the virtual accelerator for execution. While functioning as a virtual accelerator, the computing resources are dedicated to the artificial intelligence task (e.g., execution of the compiled program), allowing for temporary outputs to remain resident on the computing resources (e.g., scratch pads, caches, etc.) during the lifetime of the current task’s execution. Based on completing the task (e.g., artificial intelligence task), the virtual accelerator returns the result via shared memory back to the originating task (e.g., operating system) and is now available to be deconstructed by request for availability to other activities, including other acceleration activities.

In one or more aspects, a computer program product is provided that includes a set of one or more computer-readable storage media, and program instructions, collectively stored in the set of one or more computer-readable storage media, for causing at least one computing device to perform computer operations. The computer operations include dynamically constructing a virtual accelerator on-demand to be used to execute one or more artificial intelligence tasks. The dynamically constructing the virtual accelerator on-demand includes determining computing resources to be allocated to the virtual accelerator on-demand. The determining is based on the one or more artificial intelligence tasks to be executed. The computing resources are allocated to the virtual accelerator on-demand based on the computing resources determined to be allocated. The allocating the computing resources includes assigning at least a portion of the computing resources to the virtual accelerator on-demand from standby computing resources. The computing resources allocated to the virtual accelerator are to be used by the virtual accelerator to execute the one or more artificial intelligence tasks. By dynamically constructing a virtual accelerator on-demand, processing within a computing environment is improved. Performance of mainline tasks is improved by not having the artificial intelligence tasks interfere with the mainline tasks since they are using separate computing resources. By using standby resources as the computing resources to be allocated on-demand, performance within a computing environment is improved since computing resources that otherwise would not be used are used to perform tasks.

Additionally, or alternatively, in one example, the computing resources include memory. Allocating memory on-demand to a virtual accelerator enables the virtual accelerator to be constructed and used for tasks, such as artificial intelligence tasks, improving performance of those tasks and processing within a computing device by reducing memory latencies for mainline tasks.

Additionally, or alternatively, in one example, the memory is standby private compute memory hardware reserved for specialty engines, and the virtual accelerator is a specialty engine. By using standby private compute memory hardware, memory otherwise not being used is allocated to the virtual accelerator leaving mainline memory available for other tasks, which in turn improves performance of the other tasks and processing within the computing device. Further, it makes possible the virtual accelerator which improves processing by performing selected tasks, such as artificial intelligence tasks.

Additionally, or alternatively, in one example, the computing resources include compute resources. Allocating compute resources on-demand to a virtual accelerator enables the virtual accelerator to be constructed and used for tasks, such as artificial intelligence tasks, improving performance of those tasks and processing within a computing device by leaving mainline compute resources for mainline tasks.

Additionally, or alternatively, in one example, the compute resources are standby processor resources. By using standby processor resources, processor resources otherwise not being used are allocated to the virtual accelerator leaving mainline processor resources available for other tasks, which in turn improves performance of the other tasks and processing within the computing device. Further, it makes possible the virtual accelerator which improves processing by performing selected tasks, such as artificial intelligence tasks.

Additionally, or alternatively, in one example, the one or more artificial intelligence tasks include execution of at least one artificial intelligence model compiled into a compiled program. Using a virtual accelerator constructed on-demand for artificial intelligence tasks, including execution of an artificial intelligence model compiled into a compiled program, improves performance of the program, as well as performance of mainline applications that do not have to compete for compute resources.

Additionally, or alternatively, in one example, the dynamically constructing the virtual accelerator is performed by firmware based on a request from an operating system, and the dynamically constructing the virtual accelerator includes the firmware interacting with hardware to accumulate the computing resources to be allocated. Improvements are gained by using firmware and hardware to construct, on-demand, a virtual accelerator. Hardware is aware of the available resources and is able to directly provide this information to firmware, which uses the information to construct the virtual accelerator for use by the operating system. This communication improves the construction process, which improves processing speed and reduces communication latencies.

Additionally, or alternatively, in one example, the dynamically constructing the virtual accelerator is performed based on a request from an operating system and includes using a set of parameters obtained from the operating system to identify a configuration for the virtual accelerator. By having the operating system provide parameters for the configuration of the virtual accelerator, a virtual accelerator tailored to the task to be performed is constructed on-demand. This reduces the risk of over allocating resources, leaving resources for execution of other tasks. It also ensures that the right type and amount of resources are allocated to the virtual accelerator providing a virtual accelerator that is capable of executing the task in a manner that satisfies certain objectives.

Additionally, or alternatively, in one example, the allocating the computing resources based on the computing resources determined to be allocated includes using configuration parameters obtained from hardware to construct the virtual accelerator. Hardware is aware of the available resources and is able to provide configuration parameters to the firmware ensuring that the firmware constructs a virtual accelerator that satisfies certain criteria and is able to improve processing within the computing environment.

Additionally, or alternatively, in one example, the computer operations further include receiving an indication that the virtual accelerator has completed execution of the one or more artificial intelligence tasks, and deconstructing the virtual accelerator based on receiving the indication. By deconstructing the virtual accelerator, the computing resources are readily available for execution of other tasks, which improves system performance by having available compute and memory resources to be used by the other tasks. This facilitates keeping the other tasks from interfering with mainline tasks, improving performance and memory access.

Additionally, or alternatively, in one example, the computer operations further include determining, based on a request to execute the one or more artificial intelligence tasks and based on one or more characteristics of the one or more artificial intelligence tasks, that the virtual accelerator is to be dynamically constructed, and the dynamically constructing the virtual accelerator on-demand is performed based on the determining that the virtual accelerator is to be dynamically constructed. Dynamically constructing a virtual accelerator on-demand improves performance of the tasks to be executed by the virtual accelerator, as well as the tasks to be performed using mainline compute resources. By constructing the virtual accelerator dynamically, the compute resources used for the virtual accelerator remain available for use by other tasks until needed for the virtual accelerator. This improves performance within the computing environment.

In accordance with one or more aspects, each of the embodiments is separable and optional from one another. Further, features of an embodiment may be separable and optional from each other. Moreover, embodiments and/or features may be combined with one another.

In one or more aspects, a computer system is provided that includes a set of one or more computer-readable storage media and program instructions, collectively stored in the set of one or more computer-readable storage media, for causing at least one computing device to perform computer operations. The computer operations include dynamically constructing a virtual accelerator on-demand to be used to execute one or more artificial intelligence tasks. The dynamically constructing the virtual accelerator on-demand includes determining computing resources to be allocated to the virtual accelerator on-demand. The determining is based on the one or more artificial intelligence tasks to be executed. The computing resources are allocated to the virtual accelerator on-demand based on the computing resources determined to be allocated. The allocating the computing resources includes assigning at least a portion of the computing resources to the virtual accelerator on-demand from standby computing resources. The computing resources allocated to the virtual accelerator are to be used by the virtual accelerator to execute the one or more artificial intelligence tasks. By dynamically constructing a virtual accelerator on-demand, processing within a computing environment is improved. Performance of mainline tasks are improved by not having the artificial intelligence tasks interfere with the mainline tasks since they are using separate computing resources. By using standby resources as the computing resources to be allocated on-demand, performance within a computing environment is improved since computing resources that otherwise would not be used are used to perform tasks.

Additionally, or alternatively, in one example, the computing resources include memory. In one embodiment, the memory is standby private compute memory hardware reserved for specialty engines. The virtual accelerator is a specialty engine. Allocating memory on-demand to a virtual accelerator enables the virtual accelerator to be constructed and used for tasks, such as artificial intelligence tasks, improving performance of those tasks and processing within a computing device by reducing memory latencies for mainline tasks. By using standby private compute memory, memory otherwise not being used is allocated to the virtual accelerator leaving mainline memory available for other tasks, which in turn improves performance of the other tasks and processing within the computing device. Further, it makes possible the virtual accelerator which improves processing by performing selected tasks, such as artificial intelligence tasks.

Additionally, or alternatively, in one example, the dynamically constructing the virtual accelerator is performed by firmware based on a request from an operating system, and the dynamically constructing the virtual accelerator includes the firmware interacting with hardware to accumulate the computing resources to be allocated. Improvements are gained by using firmware and hardware to construct, on-demand, a virtual accelerator. Hardware is aware of the available resources and is able to directly provide this information to firmware, which uses the information to construct the virtual accelerator for use by the operating system. This communication improves the construction process, which improves processing speed and reduces communication latencies.

Additionally, or alternatively, in one example, the computer operations further include receiving an indication that the virtual accelerator has completed execution of the one or more artificial intelligence tasks, and deconstructing the virtual accelerator based on receiving the indication. By deconstructing the virtual accelerator, the computing resources are readily available for execution of other tasks, which improves system performance by having available compute and memory resources to be used by the other tasks. This facilitates keeping the other tasks from interfering with mainline tasks, improving performance and memory access.

In accordance with one or more aspects, each of the embodiments is separable and optional from one another. Further, features of an embodiment may be separable and optional from each other. Moreover, embodiments and/or features may be combined with one another.

In one or more aspects, a method is provided that includes dynamically constructing a virtual accelerator on-demand to be used to execute one or more artificial intelligence tasks. The dynamically constructing the virtual accelerator on-demand includes determining computing resources to be allocated to the virtual accelerator on-demand. The determining is based on the one or more artificial intelligence tasks to be executed. The computing resources are allocated to the virtual accelerator on-demand based on the computing resources determined to be allocated. The allocating the computing resources includes assigning at least a portion of the computing resources to the virtual accelerator on-demand from standby computing resources. The computing resources allocated to the virtual accelerator are to be used by the virtual accelerator to execute the one or more artificial intelligence tasks. By dynamically constructing a virtual accelerator on-demand, processing within a computing environment is improved. Performance of mainline tasks are improved by not having the artificial intelligence tasks interfere with the mainline tasks since they are using separate computing resources. By using standby resources as the computing resources to be allocated on-demand, performance within a computing environment is improved since computing resources that otherwise would not be used are used to perform tasks.

Additionally, or alternatively, in one example, the computing resources include memory. In one embodiment, the memory is standby private compute memory hardware reserved for specialty engines. The virtual accelerator is a specialty engine. Allocating memory on-demand to a virtual accelerator enables the virtual accelerator to be constructed and used for tasks, such as artificial intelligence tasks, improving performance of those tasks and processing within a computing device by reducing memory latencies for mainline tasks. By using standby private compute memory, memory otherwise not being used is allocated to the virtual accelerator leaving mainline memory available for other tasks, which in turn improves performance of the other tasks and processing within the computing device. Further, it makes possible the virtual accelerator which improves processing by performing selected tasks, such as artificial intelligence tasks.

Additionally, or alternatively, in one example, the dynamically constructing the virtual accelerator is performed by firmware based on a request from an operating system, and the dynamically constructing the virtual accelerator includes the firmware interacting with hardware to accumulate the computing resources to be allocated. Improvements are gained by using firmware and hardware to construct, on-demand, a virtual accelerator. Hardware is aware of the available resources and is able to directly provide this information to firmware, which uses the information to construct the virtual accelerator for use by the operating system. This communication improves the construction process, which improves processing speed and reduces communication latencies.

Additionally, or alternatively, in one example, the method further includes receiving an indication that the virtual accelerator has completed execution of the one or more artificial intelligence tasks, and deconstructing the virtual accelerator based on receiving the indication. By deconstructing the virtual accelerator, the computing resources are readily available for execution of other tasks, which improves system performance by having available compute and memory resources to be used by the other tasks. This facilitates keeping the other tasks from interfering with mainline tasks, improving performance and memory access.

Additionally, or alternatively, in one example, the method further includes determining, based on a request to execute the one or more artificial intelligence tasks and based on one or more characteristics of the one or more artificial intelligence tasks, that the virtual accelerator is to be dynamically constructed, and the dynamically constructing the virtual accelerator on-demand is performed based on the determining that the virtual accelerator is to be dynamically constructed. Dynamically constructing a virtual accelerator on-demand improves performance of the tasks to be executed by the virtual accelerator, as well as the tasks to be performed using mainline compute resources. By constructing the virtual accelerator dynamically, the compute resources used for the virtual accelerator remain available for use by other tasks until needed for the virtual accelerator. This improves performance within the computing environment.

In accordance with one or more aspects, each of the embodiments is separable and optional from one another. Further, features of an embodiment may be separable and optional from each other. Moreover, embodiments and/or features may be combined with one another.

In one or more aspects, a computer program product is provided that includes a set of one or more computer-readable storage media, and program instructions, collectively stored in the set of one or more computer-readable storage media, for causing at least one computing device to perform computer operations. The computer operations include receiving by a virtual accelerator an indication of an artificial intelligence task to be executed by the virtual accelerator. The virtual accelerator is dynamically constructed on-demand. The virtual accelerator is dynamically allocated computing resources on-demand based on the artificial intelligence task to be executed. At least a portion of the computing resources allocated on-demand are from standby computing resources. The artificial intelligence task is executed by the virtual accelerator. A result of the executing the artificial intelligence task is output from the virtual accelerator. The result is provided to an operating system requesting that the artificial intelligence task be executed. By dynamically constructing a virtual accelerator on-demand, processing within a computing environment is improved. Performance of mainline tasks are improved by not having the artificial intelligence tasks interfere with the mainline tasks since they are using separate computing resources. By using standby resources as the computing resources to be allocated on-demand, performance within a computing environment is improved since computing resources that otherwise would not be used are used to perform tasks.

Additionally, or alternatively, in one example, the computing resources include memory. Allocating memory on-demand to a virtual accelerator enables the virtual accelerator to be constructed and used for tasks, such as artificial intelligence tasks, improving performance of those tasks and processing within a computing device by reducing memory latencies for mainline tasks.

Additionally, or alternatively, in one example, the computing resources include compute resources. Allocating compute resources (e.g., processor(s)) on-demand to a virtual accelerator enables the virtual accelerator to be constructed and used for tasks, such as artificial intelligence tasks, improving performance of those tasks and processing within a computing device by leaving mainline compute resources for mainline tasks.

Additionally, or alternatively, in one example, the virtual accelerator is deconstructed based on the virtual accelerator completing execution of the artificial intelligence task. By deconstructing the virtual accelerator, the computing resources are readily available for execution of other tasks, which improves system performance by having available compute and memory resources to be used by the other tasks. This facilitates keeping the other tasks from interfering with mainline tasks, improving performance and memory access.

In accordance with one or more aspects, each of the embodiments is separable and optional from one another. Further, features of an embodiment may be separable and optional from each other. Moreover, embodiments and/or features may be combined with one another.

In one or more aspects, a method is provided that includes receiving by a virtual accelerator an indication of an artificial intelligence task to be executed by the virtual accelerator. The virtual accelerator is dynamically constructed on-demand. The virtual accelerator is dynamically allocated computing resources on-demand based on the artificial intelligence task to be executed. At least a portion of the computing resources allocated on-demand are from standby computing resources. The artificial intelligence task is executed by the virtual accelerator. A result of the executing the artificial intelligence task is output from the virtual accelerator. The result is provided to an operating system requesting that the artificial intelligence task be executed. By dynamically constructing a virtual accelerator on-demand, processing within a computing environment is improved. Performance of mainline tasks are improved by not having the artificial intelligence tasks interfere with the mainline tasks since they are using separate computing resources. By using standby resources as the computing resources to be allocated on-demand, performance within a computing environment is improved since computing resources that otherwise would not be used are used to perform tasks.

In accordance with one or more aspects, each of the embodiments is separable and optional from one another. Further, features of an embodiment may be separable and optional from each other. Moreover, embodiments and/or features may be combined with one another.

In one or more aspects, a computer program product is provided that includes a set of one or more computer-readable storage media, and program instructions, collectively stored in the set of one or more computer-readable storage media, for causing at least one computing device to perform computer operations. The computer operations include dynamically constructing a virtual accelerator on-demand to be used to execute one or more artificial intelligence tasks. The dynamically constructing the virtual accelerator on-demand includes determining computing resources to be allocated to the virtual accelerator on-demand. The determining is based on the one or more artificial intelligence tasks to be executed. The computing resources are allocated to the virtual accelerator on-demand based on the computing resources determined to be allocated. The allocating the computing resources includes assigning at least a portion of the computing resources to the virtual accelerator on-demand from standby computing resources. The computing resources allocated to the virtual accelerator are to be used by the virtual accelerator to execute the one or more artificial intelligence tasks. The computing resources include memory and compute resources. The compute resources are standby processor resources, and the memory is standby private compute memory hardware reserved for specialty engines. The virtual accelerator is a specialty engine. By dynamically constructing a virtual accelerator on-demand, processing within a computing environment is improved. Performance of mainline tasks is improved by not having the artificial intelligence tasks interfere with the mainline tasks since they are using separate computing resources. By using standby resources as the computing resources to be allocated on-demand, performance within a computing environment is improved since computing resources that otherwise would not be used are used to perform tasks. Allocating memory on-demand to a virtual accelerator enables the virtual accelerator to be constructed and used for tasks, such as artificial intelligence tasks, improving performance of those tasks and processing within a computing device by reducing memory latencies for mainline tasks. By using standby private compute memory hardware, memory otherwise not being used is allocated to the virtual accelerator leaving mainline memory available for other tasks, which in turn improves performance of the other tasks and processing within the computing device. Further, it makes possible the virtual accelerator which improves processing by performing selected tasks, such as artificial intelligence tasks. Allocating compute resources on-demand to a virtual accelerator enables the virtual accelerator to be constructed and used for tasks, such as artificial intelligence tasks, improving performance of those tasks and processing within a computing device by leaving mainline compute resources for mainline tasks. By using standby processor resources, processor resources otherwise not being used are allocated to the virtual accelerator leaving mainline processor resources available for other tasks, which in turn improves performance of the other tasks and processing within the computing device. Further, it makes possible the virtual accelerator which improves processing by performing selected tasks, such as artificial intelligence tasks.

In one or more aspects, a computer program product is provided that includes a set of one or more computer-readable storage media, and program instructions, collectively stored in the set of one or more computer-readable storage media, for causing at least one computing device to perform computer operations. The computer operations include dynamically constructing a virtual accelerator on-demand to be used to execute one or more artificial intelligence tasks. The dynamically constructing the virtual accelerator on-demand includes determining computing resources to be allocated to the virtual accelerator on-demand. The determining is based on the one or more artificial intelligence tasks to be executed. The computing resources are allocated to the virtual accelerator on-demand based on the computing resources determined to be allocated. The allocating the computing resources includes assigning at least a portion of the computing resources to the virtual accelerator on-demand from standby computing resources. The computing resources allocated to the virtual accelerator are to be used by the virtual accelerator to execute the one or more artificial intelligence tasks. The dynamically constructing the virtual accelerator is performed by firmware based on a request from an operating system, and the dynamically constructing the virtual accelerator includes the firmware interacting with hardware to accumulate the computing resources to be allocated. The dynamically constructing the virtual accelerator is performed based on a request from an operating system and includes using a set of parameters obtained from the operating system to identify a configuration for the virtual accelerator. By having the operating system provide parameters for the configuration of the virtual accelerator, a virtual accelerator tailored to the task to be performed is constructed on-demand. This reduces the risk of over allocating resources, leaving resources for execution of other tasks. It also ensures that the right type and amount of resources are allocated to the virtual accelerator providing a virtual accelerator that is capable of executing the task in a manner that satisfies certain objectives. Improvements are gained by using firmware and hardware to construct, on-demand, a virtual accelerator. Hardware is aware of the available resources and is able to directly provide this information to firmware, which uses the information to construct the virtual accelerator for use by the operating system. This communication improves the construction process, which improves processing speed and reduces communication latencies. By dynamically constructing a virtual accelerator on-demand, processing within a computing environment is improved. Performance of mainline tasks is improved by not having the artificial intelligence tasks interfere with the mainline tasks since they are using separate computing resources. By using standby resources as the computing resources to be allocated on-demand, performance within a computing environment is improved since computing resources that otherwise would not be used are used to perform tasks.

In one or more aspects, a computer program product is provided that includes a set of one or more computer-readable storage media, and program instructions, collectively stored in the set of one or more computer-readable storage media, for causing at least one computing device to perform computer operations. The computer operations include dynamically constructing a virtual accelerator on-demand to be used to execute one or more artificial intelligence tasks. The dynamically constructing the virtual accelerator on-demand includes determining computing resources to be allocated to the virtual accelerator on-demand. The determining is based on the one or more artificial intelligence tasks to be executed. The computing resources are allocated to the virtual accelerator on-demand based on the computing resources determined to be allocated. The allocating the computing resources includes assigning at least a portion of the computing resources to the virtual accelerator on-demand from standby computing resources. The computing resources allocated to the virtual accelerator are to be used by the virtual accelerator to execute the one or more artificial intelligence tasks. The dynamically constructing the virtual accelerator is performed by firmware based on a request from an operating system, and the dynamically constructing the virtual accelerator includes the firmware interacting with hardware to accumulate the computing resources to be allocated. The dynamically constructing the virtual accelerator is performed based on a request from an operating system and includes using a set of parameters obtained from the operating system to identify a configuration for the virtual accelerator. The allocating the computing resources based on the computing resources determined to be allocated includes using configuration parameters obtained from hardware to construct the virtual accelerator. Improvements are gained by using firmware and hardware to construct, on-demand, a virtual accelerator. Hardware is aware of the available resources and is able to directly provide this information to firmware, which uses the information to construct the virtual accelerator for use by the operating system. This communication improves the construction process, which improves processing speed and reduces communication latencies. By having the operating system provide parameters for the configuration of the virtual accelerator, a virtual accelerator tailored to the task to be performed is constructed on-demand. This reduces the risk of over allocating resources, leaving resources for execution of other tasks. It also ensures that the right type and amount of resources are allocated to the virtual accelerator providing a virtual accelerator that is capable of executing the task in a manner that satisfies certain objectives. By dynamically constructing a virtual accelerator on-demand, processing within a computing environment is improved. Performance of mainline tasks is improved by not having the artificial intelligence tasks interfere with the mainline tasks since they are using separate computing resources. By using standby resources as the computing resources to be allocated on-demand, performance within a computing environment is improved since computing resources that otherwise would not be used are used to perform tasks. Hardware is aware of the available resources and is able to provide configuration parameters to the firmware ensuring that the firmware constructs a virtual accelerator that satisfies certain criteria and is able to improve processing within the computing environment.

Computer program products, computer systems and methods relating to one or more aspects are described and claimed herein. Each of the embodiments of the computer program product may be embodiments of each computer system and/or each method and vice-versa. Further, each of the embodiments is separable and optional from one another. Moreover, embodiments may be combined with one another. Further, features of an embodiment may be separable and optional from each other. Moreover, each of the embodiments and/or features of the computer program products may be combinable with aspects and/or embodiments of each computer system and/or method, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that, e.g., performs on-demand construction of virtual accelerators and/or performs one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or "CPP") is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

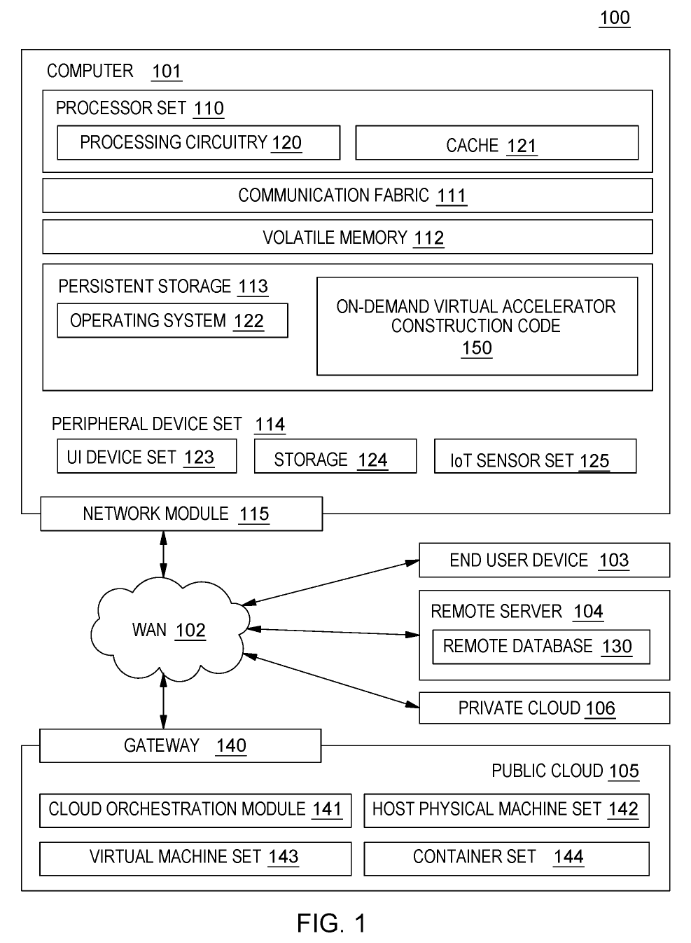

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as on-demand virtual accelerator construction code 150 (also referred to herein as block 150). In addition to construction block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located "off chip." In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as "the inventive methods"). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as "images." A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on-demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

In one or more aspects, to construct a virtual accelerator (e.g., a heterogeneous virtual accelerator) on-demand that includes, e.g., software, firmware and hardware components designed to minimize or prevent performance degradation of mainline compute workloads, on-demand virtual accelerator construction code is used. The on-demand virtual accelerator construction code is used to intelligently construct/deconstruct virtual accelerators to provide memory/compute acceleration to execute selected tasks (e.g., artificial intelligence acceleration).

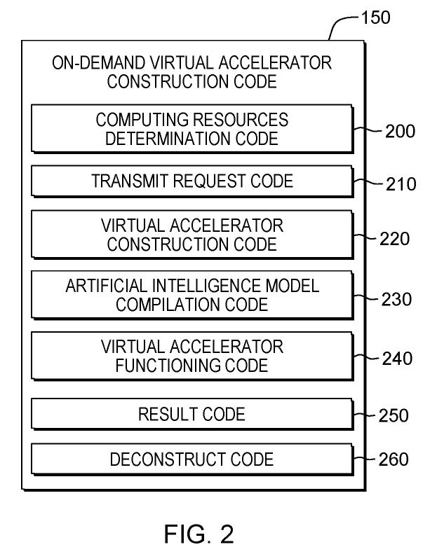

In one or more aspects, referring to FIG. 2, on-demand virtual accelerator construction code (e.g., on-demand virtual accelerator construction code 150) includes, in one example, various code to be used to intelligently and dynamically construct on-demand a virtual accelerator and/or to perform tasks relating thereto. The code is, e.g., computer-readable program code (e.g., instructions) in computer-readable media, e.g., storage (persistent storage 113, cache 121, storage 124, other storage, as examples). Although, as an example, on-demand virtual accelerator construction code 150 is depicted in FIG. 1 in persistent storage 113, the code and/or one or more portions of the code may be in other storage, such as storage 124, etc. Many variations are possible.

The computer-readable media may be part of one or more computer program products and the computer-readable program code may be executed by and/or using one or more computing devices (e.g., one or more computers, such as computer(s) 101; one or more servers, such as remote server(s) 104; one or more end user devices, such as end user device(s) 103; one or more processors or nodes, such as processor(s) or node(s) of processor set 110; processing circuitry, such as processing circuitry 120 of processor set 110; and/or other computing devices, etc.). Additional and/or other computers, servers, end user devices, processors, nodes, processing circuitry and/or other computing devices may be used to execute the code and/or portions thereof. Many examples are possible.

One example of on-demand virtual accelerator construction code 150 includes, for instance, computing resources determination code 200 to be used to determine compute and/or memory resources to be allocated to the virtual accelerator; transmit request code 210 to be used to transmit a request to construct a virtual accelerator, in which the request includes, e.g., an indication of an amount and/or type of the computing resources to be used; virtual accelerator construction code 220 to be used to construct, on-demand, a virtual accelerator; artificial intelligence model compilation code 230 to be used to compile an artificial intelligence model into a compiled program (also referred to as an application) to be executed on the virtual accelerator; virtual accelerator functioning code 240 to be used to execute the compiled program to perform one or more artificial intelligence tasks; result code 250 to be used to provide a result of executing the compiled program; and deconstruct code 260 to be used to deconstruct the virtual accelerator and return the computing resources. Additional, less and/or other code may be used to implement on-demand virtual accelerator construction. Other variations are possible. Although various code is described, on-demand virtual accelerator construction code, such as on-demand virtual accelerator construction code 150, may include additional, less and/or different code. Particular code may include additional code, less code, and/or different code. Further, additional, less and/or other code may be used for on-demand virtual accelerator construction and/or to perform related tasks. Many variations are possible.

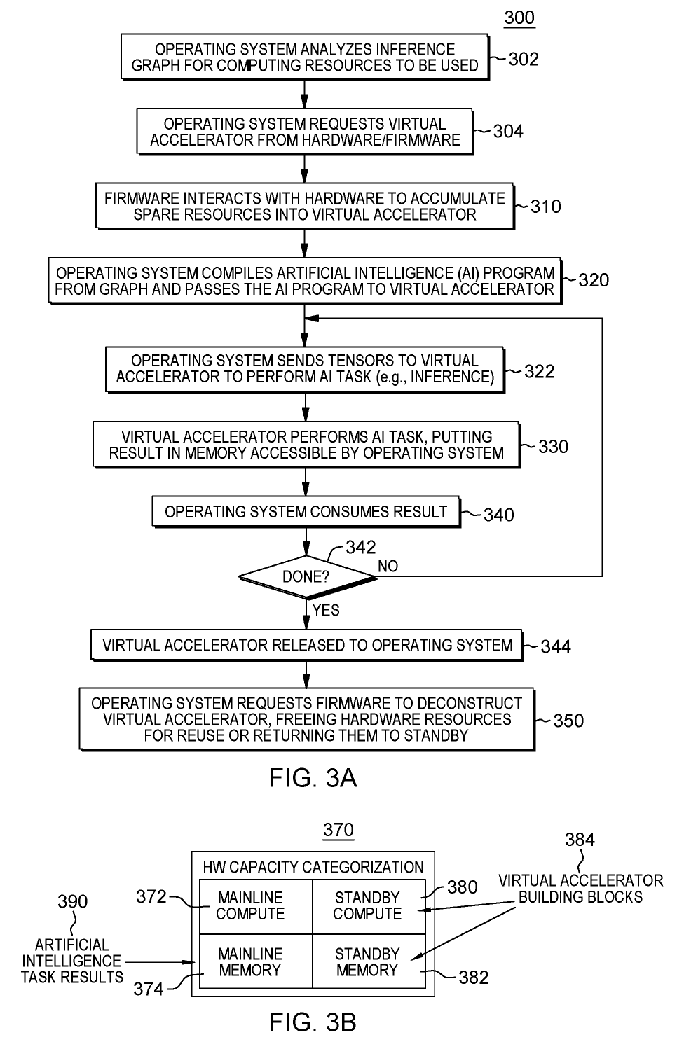

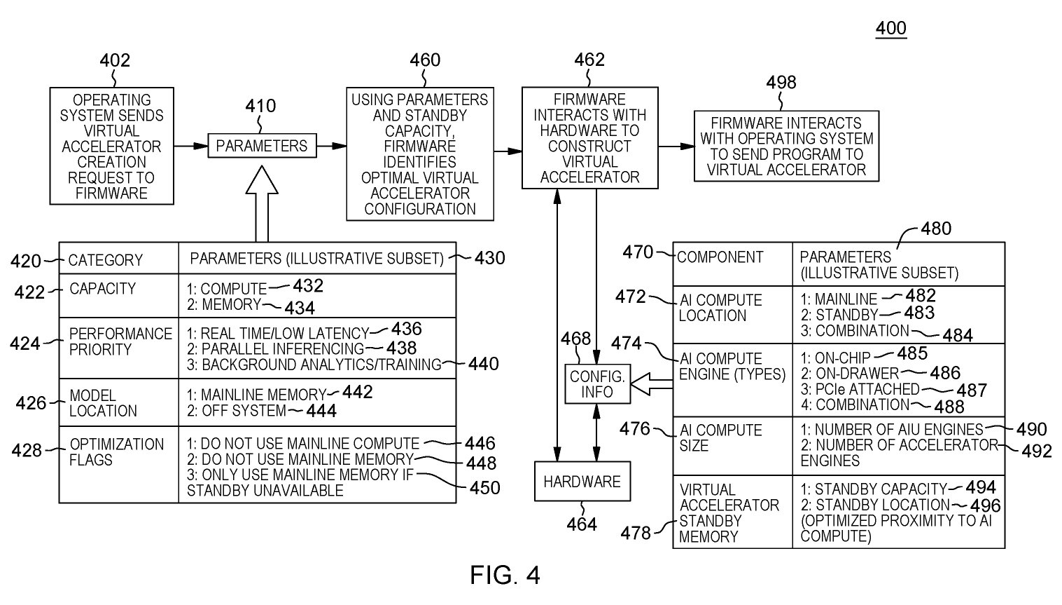

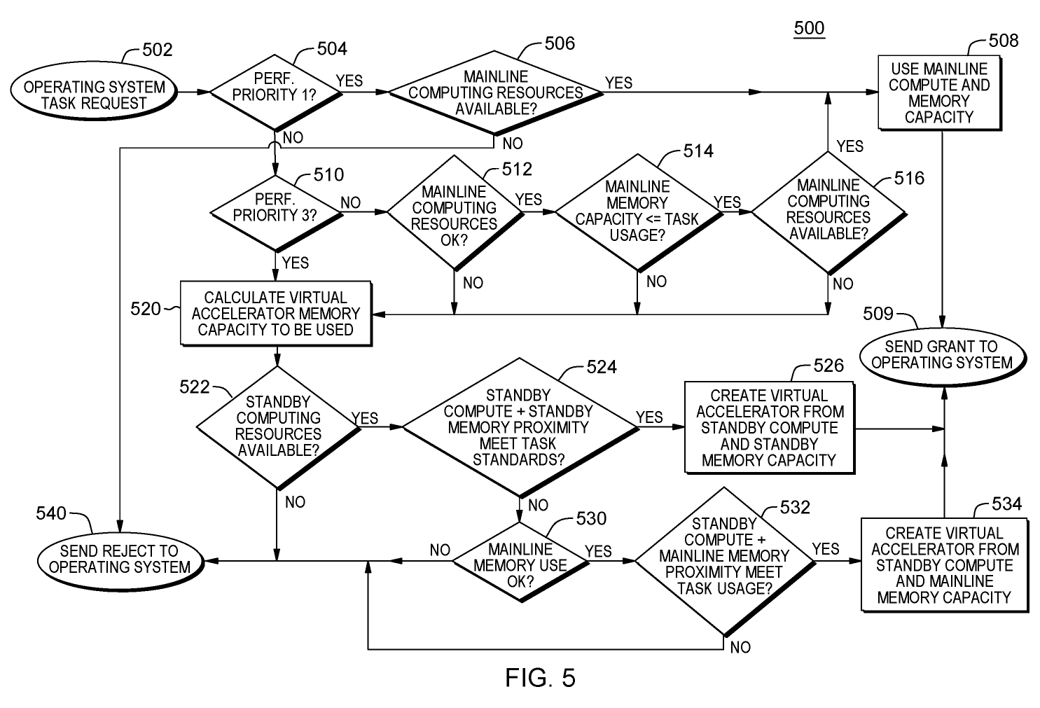

In one example, the on-demand virtual accelerator construction code (e.g., on-demand virtual accelerator construction code 150) is used, in accordance with one or more aspects of the present disclosure, to construct, on-demand, a virtual accelerator and/or to perform other tasks related thereto, as further described with reference to FIGS. 3A-5. For example, FIG. 3A depicts one example of an on-demand virtual accelerator construction and use process, in accordance with one or more aspects; FIG. 3B depicts one example of a hardware (HW) capacity categorization, in accordance with one or more aspects; FIG. 4 depicts one example of a communications process between the operating system, firmware and hardware to construct a virtual accelerator on-demand, in accordance with one or more aspects; and FIG. 5 depicts one example of an on-demand virtual accelerator construction process, in accordance with one or more aspects. In one example, each process is implemented using one or more portions of on-demand virtual accelerator construction code 150 (e.g., code 200-260) and is executed by a computing device (e.g., a computer (e.g., computer 101, other computer, etc.), a server (e.g., server 104, other server, etc.), an end user device (e.g., end user device 103, other end user device, etc.), a processor, node and/or processing circuitry, etc. (e.g., of processor set 110 or other processor sets) and/or one or more other computing devices, etc.). Although example computers, servers, end user devices, processors, nodes, processing circuitry and/or computing devices are provided, additional, fewer and/or other computers, servers, end user devices, processors, nodes, processing circuitry and/or computing devices may be used for each process and/or other processing. Various options are possible.

Referring, initially, to FIG. 3A, in one embodiment, an on-demand virtual accelerator construction and use process 300 (also referred to as process 300) includes having an operating system (e.g., an operating system task) executing on a computing device of a computing environment analyze 302 (e.g., using computing resources determination code 200) a graph, such as an inference graph, for computing resources to be used for a task, such as an artificial intelligence inference task. In other examples, the operating system determines the computing resources to be used in other ways.

The operating system requests 304 (e.g., using transmit request code 210) a virtual accelerator from the hardware/firmware of the computing environment to perform the task. In one example, the firmware receives the request and interacts with the hardware to construct the virtual accelerator, as described herein. Although in the example in FIG. 3A inferencing is the artificial intelligence task being performed, in other examples, other artificial intelligence tasks may be performed, including but not limited to, fine-tuning, encryption, security, generative artificial intelligence, etc., and/or other tasks. Other examples are possible. Further, in one example, the operating system is the z/OS^{®} operating system offered by International Business Machines Corporation, Armonk, New York. The z/OS operating system, however, is only one example operating system; other operating systems of International Business Machines Corporation and/or of other entities/companies may include and/or use one or more aspects of the present disclosure. As an example, the operating system executes on a computing device that supports a selected instruction set architecture, such as the z/Architecture^{®} instruction set architecture offered by International Business Machines Corporation, Armonk, New York. One embodiment of the z/Architecture instruction set architecture is described in a publication entitled, “z/Architecture Principles of Operation," IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present disclosure. The z/Architecture instruction set architecture and the z/OS operating system are only examples and are not meant to be limiting in any way. z/OS, z/Architecture and IBM are trademarks or registered trademarks of International Business Machines Corporation in at least one jurisdiction.

Based on the request for a virtual accelerator, the firmware, in one example, interacts 310 with the hardware of the computing environment to accumulate resources (e.g., spare resources) into the virtual accelerator. That is, the firmware, as an example, constructs (e.g., using virtual accelerator construction code 220) the virtual accelerator using standby computing resources (e.g., compute (e.g., processor) and/or memory).

In one example, the operating system compiles 320 (e.g., using artificial intelligence model compilation code 230) an artificial intelligence program from the inference graph (e.g., compiles a model providing a compiled program) and passes the compiled artificial intelligence program (also referred to as compiled program) to the virtual accelerator. The operating system sends 322, in one example, tensors (e.g., data structures of selected dimensions used to represent and manipulate data) to the virtual accelerator to perform the inference or other artificial intelligence task included in the compiled artificial intelligence program. Based thereon, in one example, the virtual accelerator performs 330 (e.g., using virtual accelerator functioning code 240) the task (e.g., executes the program that includes the task) and places the result in memory that is accessible to the operating system. The operating system consumes 340 (e.g., using result code 250) the result, and determines 342 whether processing is complete. If it is not complete, processing continues, in one example, with sending 322 tensors to the virtual accelerator. However, if it is complete, firmware releases 344 the virtual accelerator to the operating system. The operating system requests 350, in one example, that the firmware deconstruct (e.g., tear down, remove, deallocate, unassign computing resources, etc.) the virtual accelerator, freeing the hardware resources for reuse or returning them to standby, as examples. Based on the request, the firmware (e.g., using deconstruct code 260) deconstructs the virtual accelerator.

As shown in FIG. 3B, in one example, in accordance with one or more aspects, hardware (HW) capacity is categorized 370 as follows: mainline compute (e.g., processor(s)) 372 and mainline memory 374 are not used by the virtual accelerator, in one example; instead, standby compute (e.g., processor(s)) 380 and/or standby memory 382 are used as building blocks 384 for a virtual accelerator. Artificial intelligence task results 390 are returned, however, to mainline memory 374. Other examples are possible, including, but not limited to, using mainline compute and/or mainline memory.

Further details relating to constructing a virtual accelerator on-demand are described with reference to FIG. 4. FIG. 4 depicts one example of a communications process that includes communications between various entities (e.g., operating system, firmware and/or hardware) to request and construct a virtual accelerator on-demand. In one example, a communications process 400 (also referred to as process 400) includes having the operating system, as an example, send 402 (e.g., using transmit request code 210) a virtual accelerator creation request to firmware. The request includes one or more parameters 410 that describe, for instance, at least the type and/or amount of computing resources to be used for constructing the virtual accelerator. As an example, there are one or more categories 420 of parameters 430 and one or more parameters 410 are selected from a subset of parameters (e.g., parameters 430) in the one or more categories 420. Example categories 420 and parameters 430 of the categories include: a capacity category 422 having a compute parameter 432 and a memory parameter 434; a performance priority category 424 having a real time/low latency parameter 436, a parallel inferencing parameter 438, and a background analytics/training parameter 440; a model location category 426 having a mainline memory parameter 442 and an off system parameter 444; and an optimization flags category 428 having a do not use mainline compute parameter 446, a do not use mainline memory parameter 448 and an only use mainline memory if standby unavailable parameter 450. Additional, fewer and/or other examples of categories and/or parameters are possible.

Continuing with process 400, the firmware using the parameters and selected capacity (e.g., compute and/or memory capacity), such as standby capacity, identifies 460 an optimal configuration for a virtual accelerator to be constructed. A configuration is optimal if it satisfies one or more defined conditions (e.g., satisfies a certain percentage of the input parameters, satisfies one or more objectives, etc.). The firmware interacts 462 with hardware (e.g., hardware 464) to construct (e.g., using virtual accelerator construction code 220) the virtual accelerator. In one example, to construct the virtual accelerator, configuration information (e.g., configuration information 468) is used. As an example, information relating to components (e.g., example components 470) and parameters (e.g., example parameters 480) are input to configuration information 468. Example components 470 and related parameters 480 include: artificial intelligence (AI) compute location 472 having mainline parameter 482, standby parameter 483 and combination (mainline and standby) parameter 484; artificial intelligence compute engine type(s) 474 having on-chip parameter 485, on-drawer parameter 486, peripheral component interconnect (PCIe) attached accelerator parameter 487 and combination (on-chip, on-drawer and/or PCIe attached accelerator) parameter 488; an artificial intelligence compute size 476 having a number of artificial intelligence unit engines parameter 490 and a number of accelerator engines 492; and a virtual accelerator standby memory 478 having a standby capacity parameter 494 and a standby location (optimized proximity to artificial intelligence compute) parameter 496. Additional, fewer and/or other examples of components and/or parameters are possible.

The configuration information is input to, at least, the hardware (e.g., hardware 464) and used by the hardware to provide computing resources to the firmware to construct a virtual accelerator. Based on constructing the virtual accelerator, the firmware interacts 498 with, e.g., the operating system to have the operating system send one or more programs (e.g., compiled programs) to the virtual accelerator.

Further details relating to constructing a virtual accelerator are described with reference to FIG. 5. In one example, a computing resources determination/selection process 500 (also referred to as process 500) is used to identify computing resources to be used to construct a virtual accelerator on-demand. In one example, process 500 includes an operating system requesting 502 to execute a task (e.g., an artificial intelligence task). In one example, the operating system determines the computing resources (e.g., type and/or amount) to be used to perform the task and includes that in the request.

Based on the request, in one example, firmware determines 504 whether performance for the task is considered a selected priority (e.g., priority 1). If performance is considered the selected priority (e.g., priority 1), then firmware determines 506 whether mainline computing resources (e.g., mainline compute and mainline memory capacity) are available for the task. Based on mainline computing resources being available, the firmware indicates 508 mainline compute resources and mainline memory capacity are available for the task and sends 509 a grant to the operating system. The operating system executes the task using mainline computing resources.

However, if the mainline computing resources are unavailable (506), then based on the priority being the selected priority, the firmware sends 540 a rejection to the operating system.

Returning to inquiry 504, if the firmware determines 504 that the performance is not considered the selected priority (e.g., priority 1), then it determines 510 if performance is considered another selected priority (e.g., priority 3). In one example, if performance is not considered the other selected priority (e.g., priority 3), then it is considered a further selected priority (e.g., priority 2). Based on being considered the further selected priority (e.g., priority 2), the firmware determines 512 whether it is acceptable to use mainline computing resources to perform the task. If it is acceptable to use the mainline computing resources to perform the task, then firmware determines 514 whether mainline memory capacity has a selected relationship (e.g., less than or equal to) with task usage. Based on the mainline memory capacity having the selected relationship with task usage, firmware determines 516 whether mainline computing resources (e.g., compute and memory) are available. Based on mainline compute resources being available, the firmware indicates 508 mainline compute resources and mainline memory capacity are available for the task and sends 509 a grant to the operating system. The operating system executes the task using mainline computing resources.

Returning to inquiries 510, 512, 514 and 516 based on the performance being considered the other selected priority (e.g., priority 3 (510)), the mainline computing resources not being acceptable to use (512), the mainline capacity not having the predefined relationship with task usage (514) or the mainline computing resources not being available (516), the firmware calculates 520, e.g., an amount of memory capacity to be used for a virtual accelerator to be constructed on-demand. In one example, this is determined based on the task to be performed and/or the parameters provided by the operating system.

Based on calculating the virtual accelerator memory capacity to be used, the firmware determines 522 whether there is standby computing resources available to construct the virtual accelerator. If there are standby computing resources available, the firmware determines 524 whether standby compute resources plus standby memory proximity meets the task usage standards. If there is adequate standby compute plus standby memory proximity, firmware creates 526 the virtual accelerator from the standby compute and standby memory capacity. However, if firmware determines 524 that the standby compute resources plus standby memory proximity does not meet the task usage standards, then firmware determines 530 whether mainline memory is acceptable to use for the virtual accelerator. Based on the mainline memory being acceptable to use, firmware determines 532 whether the standby compute resources plus mainline memory proximity meets task usage. If there is adequate standby compute plus mainline memory proximity to meet task usage, firmware creates 534 the virtual accelerator from the standby compute and mainline memory capacity.

Based on creating the virtual accelerator (e.g., from the standby compute resources and mainline memory capacity 534 or the standby compute resources and the standby memory capacity 526), the firmware sends 509 an indication to the operating system that the request to execute the task is granted. The task is executed on the virtual accelerator constructed on-demand.

Returning to inquiries 522, 530 and 532, based on the standby computing resources being unavailable (522), the mainline memory being unacceptable to use (530) or the standby compute plus mainline memory proximity not meeting task usage (532), the firmware sends 540 a rejection to the operating system indicating that it is not to execute the task.

In the example in FIG. 5, the operating system requests that a task be performed and the firmware determines whether a virtual accelerator is to be constructed on-demand. However, in other examples (e.g., FIG. 3A), the operating system may request use of a virtual accelerator and the firmware constructs the virtual accelerator using either mainline and/or standby computing resources. In other examples, based on the request of a virtual accelerator, firmware performs process 500. Other examples are possible.

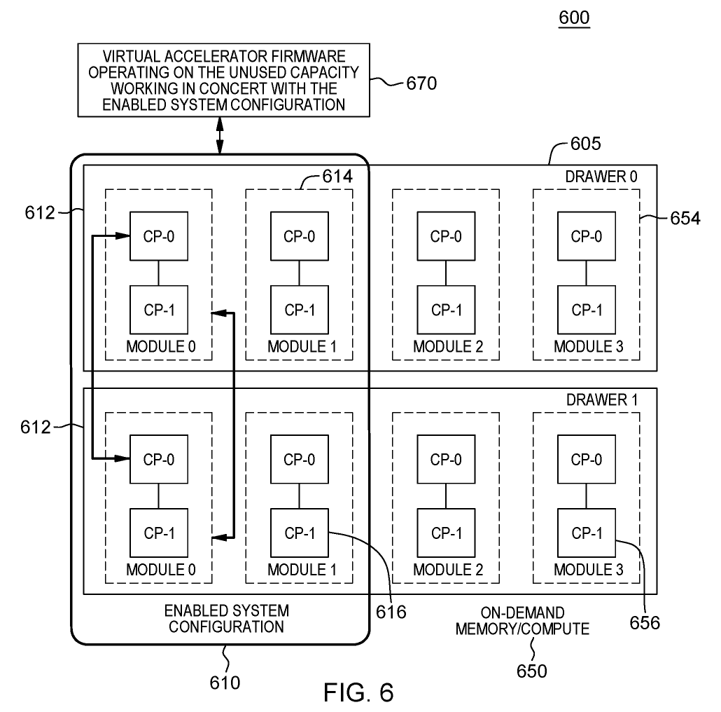

In one or more aspects, a virtual accelerator is constructed on-demand. One example of a hardware configuration illustrating use of resources for an on-demand virtual accelerator is depicted in FIG. 6. In one example, a system 600 includes, for instance, a box 605 (e.g., a system) that includes, e.g., an enabled system configuration 610 and an unenabled configuration that may be used as on-demand memory/compute 650. In one example, box 605 includes, for instance, two drawers 612 (e.g., drawer 0 and drawer 1), and each drawer 612 includes, e.g., four modules 614 (e.g., modules 0-3). Each module 614 is, for instance, a chip and includes, for instance, two central processors 616 (e.g., CP-0, CP-1). In one or more other examples, there may be more or fewer drawers, modules and/or central processors. The numbers provided herein are just one example. Thus, in one example, enabled system configuration 610 has use of eight central processors 616 for mainline tasks. That is, it has use of a portion (e.g., 50 %) of the modules 614 and central processors 616.

Further, in one example, on-demand memory/compute 650 has available to it another portion (e.g., 50 %) of modules 614 (e.g., modules 654)/central processors 616 (e.g., central processors 656) that is included in the box (e.g., box 605) but not enabled. This unused compute plus memory resources may be activated on-demand for real-time artificial intelligence workload acceleration (or other tasks). For instance, in accordance with one or more aspects, on-demand memory/compute configuration 650 is provided that is fully connected to enabled system configuration 610 via, e.g., one or more network connections (e.g., buses, links, etc.).

Having an enabled system configuration (e.g., enabled system configuration 610) and an on-demand memory/compute configuration (e.g., on-demand memory/compute 650) allows 670 a virtual accelerator (e.g., virtual accelerator firmware) to operate on unused capacity in concert with the enabled system configuration. In one or more examples, the operating system is able to leverage as a virtual accelerator the following: additional vL3/vL4 (virtual level 3/virtual level 4) caches (+1.5 GB (gigabytes) vL4 per drawer, private to on-demand compute); at least 25 % (8-32 TB (terabytes)) additional DIMM (dual in-line memory module) memory private to on-demand compute; up to, e.g., eight additional (2x) on-chip artificial intelligence units per drawer; up to, e.g., eight instruction set architecture clusters per drawer; and, e.g., six more peripheral component interconnect express (and/or other interconnect) ports to connect additional memory and/or additional compute resources. Other examples are possible.

In accordance with one or more aspects, an effective virtual accelerator is constructed that has, for instance, eight dedicated central processors (e.g., central processing units). That provides, e.g., 8-16 artificial intelligence units worth of extra artificial intelligence compute capacity dedicated to a virtual accelerator task. A feedback-based loop based on memory latencies is provided that updates the routing algorithm. Size, latency, throughput usage and monitoring of service level agreements are provided. A dispatchable work unit from the system configuration runs on dedicated virtual accelerator resources, which reduces data access, sharing and consistency requirements between artificial intelligence units due to dedicated tasks, and is asynchronous from the original task (e.g., mainline task). Artificial intelligence inference runs in full in the context of the virtual accelerator. In one example, there is no implicit sharing of state or checkpointing. There is, e.g., real-time customization of virtual accelerator size for the artificial intelligence task. For example, if there is no need for, e.g., eight artificial intelligence units, then the process carves out a smaller number and the remaining hardware resources are then available to be used for another virtual accelerator. Other examples are possible.

Although an example configuration is provided herein, many other configurations are possible including having an entire drawer available for on-demand virtual accelerators. For instance, an existing central processor drawer may be dedicated to on-demand processing or another type of drawer (e.g., an input/output drawer) may be re-purposed for on-demand processing. Further, in other examples: cores and/or caches of bad chips may be used; artificial intelligence units may be available for use cross-drawer so any core in the system can use them; attached memory and I/O may be used to support memory intensive artificial intelligence workloads; the available on-chip cache may be used for artificial intelligence workloads, etc.

In one example configuration, a fifth drawer may have, for instance: 20 terabytes of DIMM memory (via, e.g., five microcontroller unit controllers); limited cores for artificial intelligence/memory control or none and cores from other drawers would initiate the operations into artificial intelligence unit/memory; e.g., 16 artificial intelligence units to choose from, e.g., two per chip; have a total of, e.g., 3Gb+ of cached L3's that would be given to artificial intelligence units usage (in the cases of no artificial intelligence unit use, that drawer could be, e.g., a virtual L5 for four drawers to cast-out to if the latency is good enough to avoid going out to memory (three chips that do not contain microcontroller unit + dual in-line memory module, can be wired up to have, e.g., a high-speed interconnect drawer + the microcontroller unit + dual in-line memory module (if power or packaging allows)); e.g., eight shadow with reduced instruction set (e.g., Risc-V) data processing unit (DPU), and if those Risc-Vs can be used for artificial intelligence unit enablement or other processing use cases, then that's extra power to be engaged on the 5th drawer. Other examples and embodiments are possible.

In one example, in the fifth drawer configuration, if have a high-speed interconnect attached memory, software may be used to determine what data is acceptable to be at a certain latency (e.g., 350 ns (nanoseconds)), what would benefit from being cached, what selected memory does not need to be persisted and what data to have lower latency (e.g., >1 ns) and is to be in the DIMMS. Further, in one example, software potentially creates a capability to guarantee that the data/memory that's being used for an artificial intelligence unit workload and is moved to the artificial intelligence drawer is not to be accessed by the rest of the system. Many other possibilities exist, as well as other configuration examples.

In one or more aspects, manual (human) decision making is not needed to route work to a virtual accelerator (e.g., a peripheral component interconnect express (PCIe)-attached accelerator card).

In one or more aspects, a capability is provided to construct one or more virtual accelerators on-demand. The demand for artificial intelligence compute resources on the mainframe is on the rise due to expanding use cases for real-time inferencing acceleration, generative artificial intelligence, security, encryption, fine-tuning, etc. Artificial intelligence hardware located at or near processors can degrade traditional enterprise workload performance. Near-processor artificial intelligence compute is optimal for some use cases, but many of the artificial intelligence workloads would benefit from being close to large blocks of memory (TBs-terabytes). Isolating non-performance critical artificial intelligence compute and its memory space from performance critical workloads is a goal.

One or more aspects create and assign virtual accelerators (e.g., virtual acceleration engines) out of unused hardware memory and compute capacity.

In one or more aspects, when a client workload is to use on-demand memory/compute (e.g., to accelerate large-scale artificial intelligence inferencing and/or other artificial intelligence tasks and/or other tasks), software enables the usage via, e.g., an operating system to firmware dispatch to one or more compute engines either on the silicon or plugged via, e.g., a connection port (e.g., PCIe port) to deliver on-system artificial intelligence (AI) compute as a Service (AIaaS). The variable pool of hardware compute silicon is thereby abstracted from the point of view of software as virtual accelerators which the software can leverage as desired.

In one or more aspects, upon an inference request (or other artificial intelligence request and/or other request), the software inferencing task (e.g., an operating system task) determines the amount of computing resources to be used to accomplish the inference according to the governing service level objective. The identified computing usage is then passed to the system firmware via, e.g., the operating system to on-demand construct a virtual accelerator including the desired computing capabilities. This virtual accelerator is configured with the computing resources to be used and a minimal runtime environment to process inferencing programs (and/or other artificial intelligence programs and/or other programs) designed to utilize the computing resources. The originating task (e.g., operating system task) compiles the artificial intelligence model into an inferencing program and uses shared memory segments to pass the program and inputs to the virtual accelerator for execution. While functioning as a virtual accelerator, the extra computing resources are dedicated to the inferencing task (and/or other task), allowing for temporary outputs to remain resident on the computing resources (e.g., scratchpads, caches, etc.) during the lifetime of the execution. When finished, the virtual accelerator returns the result via, e.g., shared memory back to the originating task (e.g., operating system task) and the virtual accelerator is now available to be torn down (or otherwise deconstructed) by request for availability to other inferencing activities (and/or other activities).

In one or more aspects, otherwise unused portion(s) of a computing system are configured as “standby” private compute (e.g., processor) and memory hardware. A software/firmware technique identifies opportunities to utilize the standby compute and memory for specialty workload applications. Intelligent dispatch of work to specialty engines (e.g., virtual accelerators), depending on the nature of the work, delivers compute + memory capacity on-demand as a service. In one embodiment, no working partitions will have memory allocated in the on-demand area. This ensures the memory, interface buses and caches are exclusively available for use by the on-demand computing resources (e.g., on-chip artificial intelligence unit(s), PCIe-attached artificial intelligence unit(s), etc.), maximizing inferencing speed with little to no impact on the traditional customer workloads running on the configured portion of the system. The result of the inferencing can then be passed back to the requesting process.

In one embodiment, in a system with a portion of its cores and memory configured for customer use (e.g., a 2 half-drawer configuration), the unconfigured cores are unused, but, in one example, the caches attached to the unused cores, the input/output ports and the memory are configured for on-demand artificial intelligence acceleration use only. Other examples are possible.

In one embodiment, a fully configured system connects an additional (e.g., fifth) processor drawer (built from low-core-yield chips) via the otherwise unused bus connections on a selected module (e.g., the fourth module), which is added to the frame (e.g., C-Frame) in lieu of selected input/output (IO) drawers (e.g., the IO14 and IO13 drawers). To maintain system power constraints, the fifth drawer processing cores are, e.g., permanently depowered, but the on-chip hardware accelerators, caches and IO can be powered and utilized. Other examples are possible.

With artificial intelligence needs and solutions changing rapidly, costs and time to market are to be reduced while offering options that deliver client value. One or more aspects minimize impact of short-term artificial intelligence hardware accelerator usage on critical system workload performance to improve real-time artificial intelligence inferencing success rates at scale. A large amount of artificial intelligence acceleration with no hardware development costs overhead is provided, in one or more aspects.

In one or more aspects, a heterogeneous virtual accelerator is provided that includes software-firmware-hardware components designed to minimize or prevent performance degradation of artificial intelligence acceleration on mainline compute workloads. One or more aspects include, for instance: dynamic creation of on-demand compute plus (+) memory based on system hardware capacity and acceleration task requirements as a heterogeneous virtual accelerator, utilized when needed and depowered when not in use; a firmware dispatchable work unit from the system configuration runs on dedicated virtual accelerator resources; and the software dispatch of work to the system's virtual accelerators is based off of, e.g., artificial intelligence task characteristics.

One or more aspects provide a capability of abstracting a variable pool of hardware resources for software as virtual accelerators for efficiently performing artificial intelligence tasks that include, for instance: combined software-firmware-hardware components designed to prevent performance degradation from artificial intelligence acceleration on mainline compute workloads and enhance artificial intelligence acceleration performance; a software determination of an amount of compute/memory capabilities to accomplish inference task according to a service level objective; firmware via the operating system to on-demand construct/configure virtual accelerators including the required compute/memory capabilities; and an artificial intelligence task and its inputs using shared memory segments that are passed to the virtual accelerator for execution via software dispatch (virtual accelerator returns task results to software using shared memory segments).

In one or more aspects, a heterogeneous virtual accelerator is provided that includes software-firmware-hardware components. One or more aspects provide: hardware near-memory locality of artificial intelligence compute engines plus (+) corresponding caches in proximity to memory containing the inferencing data set, not the processor which the calling workload is running; designation of a portion of total system compute plus (+) memory as on-demand capacity that is shipped with a system, configured in a stand-by state; dynamic utilization of on-demand compute plus (+) memory as a heterogeneous virtual accelerator, utilized when needed and depowered when not in use; firmware dispatchable work unit from system configuration runs on dedicated virtual accelerator resources; and software dispatch of work to the system's virtual accelerators.

One or more aspects include a method to create and assign virtual acceleration engines from unused hardware memory and compute capacity. In one or more aspects, when a client task requires on-demand memory (e.g., to accelerate large-scale AI inferencing), one or more compute engines are enabled (via operating system to firmware dispatch) on silicon or through a PCIe port (or other port) to deliver on-system AI compute as a service (AIaaS). In one or more aspects, upon an inference request, an inferencing task determines the amount of compute needed (per service level objective). One or more aspects request, from the inference request to the operating system via the firmware, an on-demand virtual adapter (a.k.a., virtual accelerator) comprising the requested compute capabilities. One or more aspects include compiling an AI model into an inferencing program. One or more aspects include upon completion of the client task, returning the virtual accelerator computing resources to the system.

In one or more aspects, an otherwise unused portion of the system is configured as standby private compute memory hardware for use as a standby resource for specialty engines, thereby delivering compute+memory capacity on-demand as a service.

Described above is one example of on-demand construction/deconstruction of a virtual accelerator used for artificial intelligence tasks (and/or other tasks). Further details relating to artificial intelligence and training a machine learning model are described below.

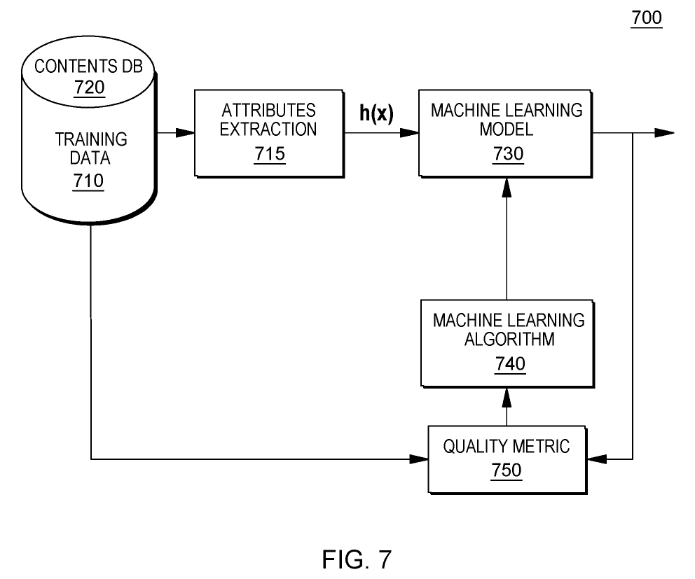

One example of a machine learning training system is described with reference to FIG. 7. In one or more aspects, a machine learning training system 700 may be utilized to perform cognitive analyses of various inputs, including input data, data from one or more sources (e.g., exogenous sources and/or other sources), repositories, data structures and/or other data. Training data 710 utilized to train the model in one or more embodiments of the present disclosure includes, for instance, data that pertains to one or more events, such as natural language processing data, data being processed; data that pertains to conversations; data obtained from exogenous sources; data pertaining to artificial intelligence tasks; actions that have been taken; and/or available resources; etc. The program code in embodiments of the present disclosure performs a cognitive analysis to generate one or more training data structures, including algorithms utilized by the program code to predict states of a given event. Machine learning (ML) solves problems that are not solved with numerical means alone. In this ML-based example, program code extracts various attributes from ML training data 710 (e.g., historical data collected from various data sources relevant to the event, which may be resident in one or more databases 720 comprising event or other data. Attributes 715 are utilized to develop a predictor function, h(x), also referred to as a hypothesis, which the program code utilizes as a machine learning model 730.

In identifying various event states, features, attribute similarities, constraints and/or behaviors indicative of states in the ML training data 710, the program code can utilize various techniques to identify attributes in an embodiment of the present disclosure. Embodiments of the present disclosure utilize varying techniques to select attributes (data attributes, elements, patterns, features, constraints, distribution, etc.), including but not limited to, diffusion mapping, principal component analysis, recursive feature elimination (a brute force approach to selecting attributes), and/or a Random Forest, to select the attributes related to various events. The program code may utilize a machine learning algorithm 740 to train the machine learning model 730 (e.g., the algorithms utilized by the program code), including providing weights for the conclusions, so that the program code can train the predictor functions that comprise the machine learning model 730. The conclusions may be evaluated by a quality metric 750. By selecting a diverse set of ML training data 710, the program code trains the machine learning model 730 to identify and weight various attributes (e.g., data attributes, features, patterns, constraints, distributions, etc.) that correlate to various states of an event.

The model generated by the program code is self-learning as the program code updates the model based on active event feedback, as well as from the feedback received from data related to the event. For example, when the program code determines that there is a constraint, event, similarity or pattern (e.g., data attribute, record attribute similarity, query pattern, data distribution, search terms distribution, etc.) that was not previously predicted by the model, the program code utilizes a learning agent to update the model to reflect the state of the event, in order to improve predictions in the future. Additionally, when the program code determines that a prediction is incorrect, either based on receiving user feedback through an interface or based on monitoring related to the event, the program code updates the model to reflect the inaccuracy of the prediction for the given period of time. Program code comprising a learning agent cognitively analyzes the data deviating from the modeled expectations and adjusts the model to increase the accuracy of the model, moving forward.

In one or more embodiments, program code, executing on one or more processors, utilizes a cognitive analysis tool or agent (now known or later developed) to tune the model, based on data obtained from one or more data sources. In one or more embodiments, the program code interfaces with application programming interfaces to perform a cognitive analysis of obtained data. Specifically, in one or more embodiments, certain application programming interfaces comprise a cognitive agent (e.g., learning agent) that includes one or more programs, including, but not limited to, natural language classifiers, a retrieve and rank service that can surface the most relevant information from a collection of documents, concepts/visual insights, trade off analytics, document conversion, and/or relationship extraction. In an embodiment, one or more programs analyze the data obtained by the program code across various sources utilizing one or more of a natural language classifier, retrieve and rank application programming interfaces, and trade off analytics application programming interfaces. An application programming interface can also provide audio related application programming interface services, in the event that the collected data includes audio, which can be utilized by the program code, including but not limited to natural language processing, text to speech capabilities, and/or translation.

In one or more embodiments, the program code utilizes a neural network to analyze event-related data to generate the model utilized to predict the state of a given event at a given time. Neural networks are biologically-inspired programming paradigms, which enable a computer to learn and solve artificial intelligence problems. This learning is referred to as deep learning, which is a subset of machine learning, an aspect of artificial intelligence, and includes a set of techniques for learning in neural networks. Neural networks, including modular neural networks, are capable of pattern recognition with speed, accuracy, and efficiency, in situations where data sets are multiple and expansive, including across a distributed network, including but not limited to, cloud computing systems. Modern neural networks are non-linear statistical data modeling tools. They are usually used to model complex relationships between inputs and outputs or to identify patterns (or similarities) in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in multiple source processing, which the program code in one or more embodiments accomplishes when obtaining data and generating a model for predicting states of a given event.

One or more aspects of the present disclosure are tied to computer technology and facilitate processing within a computer, improving performance thereof. For instance, on-demand compute and/or memory resources are provided, which improves performance by allowing idle compute/memory resources to be used.

One or more aspects: provide future proofing by enabling high-end server designs to expand artificial intelligence compute capacity without the creation of new hardware out of the project delivery roadmap cycle; expand opportunities for parallelization of heterogeneous and homogeneous artificial intelligence workloads by enabling software to construct virtual accelerators (e.g., virtual acceleration engines) sized to meet the task at hand (leaving remaining hardware components available for other virtual accelerators); allow software hypervisor-like level of control of hardware resources used to construct virtual accelerators; and/or increases artificial intelligence compute while minimizing negative performance impacts due to sharing of hardware resources between artificial intelligence and non-artificial intelligence transaction workloads via routing the work to entirely separate different hardware components.

One or more aspects enable enterprise customers to scale their hardware accelerated compute on enterprise computing systems. This enables the expansion of real-time inference while simultaneously enabling new artificial intelligence use cases that are less time sensitive but still require security, resiliency and confidentiality provided by keeping the workload on a selected architectural box. Examples include, but are not limited to, safe and ethical training, fine-tuning, security, encryption, etc. Real-time inferencing and other latency critical artificial intelligence tasks can be dispatched to engines in close proximity to the requesting processor running the calling workload, while other, less latency critical tasks can be dispatched to a virtual accelerator that is physically further away (e.g., off module/off drawer) but with private usage of the compute capacity and resources for the duration of the task.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet as a further aspect, a process for integrating computing infrastructure comprising integrating computer-readable code into a computer system may be provided. The computer system comprises a computer-readable medium, in which the computer-readable medium comprises one or more embodiments. The code in combination with the computer system is capable of performing one or more embodiments.

Although various embodiments are described above, these are only examples. For example, other systems, configurations and/or architectures may be used and/or benefit from one or more aspects of the present disclosure. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product comprising:
a set of one or more computer-readable storage media; and
program instructions, collectively stored in the set of one or more computer-readable storage media, for causing at least one computing device to perform computer operations including:
dynamically constructing a virtual accelerator on-demand to be used to execute one or more artificial intelligence tasks, wherein the dynamically constructing the virtual accelerator on-demand includes:
determining computing resources to be allocated to the virtual accelerator on-demand, the determining being based on the one or more artificial intelligence tasks to be executed; and
allocating the computing resources to the virtual accelerator on-demand based on the computing resources determined to be allocated, wherein the allocating the computing resources includes assigning at least a portion of the computing resources to the virtual accelerator on-demand from standby computing resources, and wherein the computing resources allocated to the virtual accelerator are to be used by the virtual accelerator to execute the one or more artificial intelligence tasks.

2. The computer program product of claim 1, wherein the computing resources include memory.

3. The computer program product of claim 2, wherein the memory is standby private compute memory hardware reserved for specialty engines, and wherein the virtual accelerator is a specialty engine.

4. The computer program product of claim 1, wherein the computing resources include compute resources.

5. The computer program product of claim 4, wherein the compute resources are standby processor resources.

6. The computer program product of claim 1, wherein the one or more artificial intelligence tasks include execution of at least one artificial intelligence model compiled into a compiled program.

7. The computer program product of claim 1, wherein the dynamically constructing the virtual accelerator is performed by firmware based on a request from an operating system, and wherein the dynamically constructing the virtual accelerator includes the firmware interacting with hardware to accumulate the computing resources to be allocated.

8. The computer program product of claim 1, wherein the dynamically constructing the virtual accelerator is performed based on a request from an operating system and includes using a set of parameters obtained from the operating system to identify a configuration for the virtual accelerator.

9. The computer program product of claim 8, wherein the allocating the computing resources based on the computing resources determined to be allocated includes using configuration parameters obtained from hardware to construct the virtual accelerator.

10. The computer program product of claim 1, wherein the computer operations further include:
receiving an indication that the virtual accelerator has completed execution of the one or more artificial intelligence tasks; and
deconstructing the virtual accelerator based on receiving the indication.

11. The computer program product of claim 1, wherein the computer operations further include determining, based on a request to execute the one or more artificial intelligence tasks and based on one or more characteristics of the one or more artificial intelligence tasks, that the virtual accelerator is to be dynamically constructed, and wherein the dynamically constructing the virtual accelerator on-demand is performed based on the determining that the virtual accelerator is to be dynamically constructed.

12. A computer system comprising:
a set of one or more computer-readable storage media; and
program instructions, collectively stored in the set of one or more computer-readable storage media, for causing at least one computing device to perform computer operations including:
dynamically constructing a virtual accelerator on-demand to be used to execute one or more artificial intelligence tasks, wherein the dynamically constructing the virtual accelerator on-demand includes:
determining computing resources to be allocated to the virtual accelerator on-demand, the determining being based on the one or more artificial intelligence tasks to be executed; and
allocating the computing resources to the virtual accelerator on-demand based on the computing resources determined to be allocated, wherein the allocating the computing resources includes assigning at least a portion of the computing resources to the virtual accelerator on-demand from standby computing resources, and wherein the computing resources allocated to the virtual accelerator are to be used by the virtual accelerator to execute the one or more artificial intelligence tasks.

13. The computer system of claim 12, wherein the computing resources include memory, and wherein the memory is standby private compute memory hardware reserved for specialty engines, and wherein the virtual accelerator is a specialty engine.

14. The computer system of claim 12, wherein the dynamically constructing the virtual accelerator is performed by firmware based on a request from an operating system, and wherein the dynamically constructing the virtual accelerator includes the firmware interacting with hardware to accumulate the computing resources to be allocated.

15. The computer system of claim 12, wherein the computer operations further include:
receiving an indication that the virtual accelerator has completed execution of the one or more artificial intelligence tasks; and
deconstructing the virtual accelerator based on receiving the indication.

16. A method comprising:
dynamically constructing a virtual accelerator on-demand to be used to execute one or more artificial intelligence tasks, wherein the dynamically constructing the virtual accelerator on-demand includes:
determining computing resources to be allocated to the virtual accelerator on-demand, the determining being based on the one or more artificial intelligence tasks to be executed; and
allocating the computing resources to the virtual accelerator on-demand based on the computing resources determined to be allocated, wherein the allocating the computing resources includes assigning at least a portion of the computing resources to the virtual accelerator on-demand from standby computing resources, and wherein the computing resources allocated to the virtual accelerator are to be used by the virtual accelerator to execute the one or more artificial intelligence tasks.

17. The method of claim 16, wherein the computing resources include memory, and wherein the memory is standby private compute memory hardware reserved for specialty engines, and wherein the virtual accelerator is a specialty engine.

18. The method of claim 16, wherein the dynamically constructing the virtual accelerator is performed by firmware based on a request from an operating system, and wherein the dynamically constructing the virtual accelerator includes the firmware interacting with hardware to accumulate the computing resources to be allocated.

19. The method of claim 16, further including:
receiving an indication that the virtual accelerator has completed execution of the one or more artificial intelligence tasks; and
deconstructing the virtual accelerator based on receiving the indication.

20. The method of claim 16, further including determining, based on a request to execute the one or more artificial intelligence tasks and based on one or more characteristics of the one or more artificial intelligence tasks, that the virtual accelerator is to be dynamically constructed, and wherein the dynamically constructing the virtual accelerator on-demand is performed based on the determining that the virtual accelerator is to be dynamically constructed.

21. A computer program product comprising:
a set of one or more computer-readable storage media; and
program instructions, collectively stored in the set of one or more computer-readable storage media, for causing at least one computing device to perform computer operations including:
receiving by a virtual accelerator an indication of an artificial intelligence task to be executed by the virtual accelerator, the virtual accelerator dynamically constructed on-demand, wherein the virtual accelerator is dynamically allocated computing resources on-demand based on the artificial intelligence task to be executed, and wherein at least a portion of the computing resources allocated on-demand are from standby computing resources;
executing, by the virtual accelerator, the artificial intelligence task; and
outputting from the virtual accelerator a result of the executing the artificial intelligence task, the result provided to an operating system requesting that the artificial intelligence task be executed.

22. The computer program product of claim 21, wherein the computing resources include memory.

23. The computer program product of claim 21, wherein the computing resources include compute resources.

24. The computer program product of claim 21, wherein the virtual accelerator is deconstructed based on the virtual accelerator completing execution of the artificial intelligence task.

25. A method comprising:
receiving by a virtual accelerator an indication of an artificial intelligence task to be executed by the virtual accelerator, the virtual accelerator dynamically constructed on-demand, wherein the virtual accelerator is dynamically allocated computing resources on-demand based on the artificial intelligence task to be executed, and wherein at least a portion of the computing resources allocated on-demand are from standby computing resources;
executing, by the virtual accelerator, the artificial intelligence task; and
outputting from the virtual accelerator a result of the executing the artificial intelligence task, the result provided to an operating system requesting that the artificial intelligence task be executed.
